(19) United States
(12) Patent Application Publication
(10) Pub. No.: US 2014/0116256 A1
(43) Pub. Date: May 1, 2014

(54) PARTICLE CONDENSING APPARATUS AND PARTICLE DETECTING APPARATUS

(71) Applicant: Azbil Corporation, Tokyo (JP)

(72) Inventors: Shinsuke YAMASAKI, Tokyo (JP); Ichitaro SATO, Tokyo (JP)

(73) Assignee: AZBIL CORPORATION, Tokyo (JP)

(21) Appl. No.: 14/063,499

(22) Filed: Oct. 25, 2013

(30) Foreign Application Priority Data
Oct. 26, 2012 (JP) 2012-237050

(51) Int. Cl. B01D 45/16; G01N 15/14

(52) U.S. Cl. CPC B01D 45/16; G01N 15/14
USPC 96/414; 55/435

(57) ABSTRACT

A particle condensing apparatus includes a gas-borne particle condensing device that condenses a gas that includes gas-borne particles. The gas-borne particle condensing device includes a cyclone portion that causes a supplied first gas to swirl along an inner wall face to cause centrifugal force to act on particles in the first gas to produce a second gas with a relatively high particle concentration and a third gas with a low particle concentration. A fluorocarbon polymer film is formed on an inner wall face of the cyclone portion.

### CROSS REFERENCE TO RELATED APPLICATION

This application claims priority under 35 U.S.C. §119 to Japanese Patent Application No. 2012-237050, filed on Oct. 26, 2012, the entire content of which being hereby incorporated herein by reference.

### FIELD OF TECHNOLOGY

The present invention relates to a particle condensing apparatus and particle detecting apparatus, and, in particular, relates to an improvement in a particle condensing apparatus and particle detecting apparatus for increasing the particle concentration in a gas using a simple structure.

### BACKGROUND

Detecting devices for detecting particles in the air and in fluids are required in manufacturing facilities and research facilities for foodstuffs, pharmaceuticals, and general industrial products. The particles in the air and in fluids, which are to be detected, are, as physical entities, not only particles, but, for example, microorganisms particles such as bacteria, funguses (such as mold, or the like), and mycoplasmas, and so forth, are also included in that which is to be detected.

When detecting microorganism particles, typically a filter for extracting microorganisms (microparticles) is used to capture and cultivate the sample particles, and colonies of cultured microparticles are observed with the naked eye or under a microscope. Moreover, recently there have been proposals for particle detecting apparatuses wherein the particles to be detected are illuminated with a detection beam (for example, a laser beam), and scattered light or fluorescent light (in the case of microorganisms) from the particles is detected. See, for example, International Patent Application Publication No. WO 2010/0080643 (“the WO '643”). This particle detecting device has the benefit of being able to detect particles in real time.

In order to both increase the analytical effectiveness (the volume of gas analyzed) for particles in the particle detector set forth above, and to detect particles in a gas more reliably, preferably a large volume of the gas that is subject to sampling is selected and the particles that are gas-borne in the gas are condensed into a specific quantity of the gas (increasing the particle concentration), and detected by the particle detecting device. For example, in the Non-Patent literature of K. S. Lim, et al. (“Particle Collection and Concentration for Cyclone Concentrators,” Aerosol Science and Technology 39:113-123, 2005, “Lim”), there is a proposal for the use of a condensing device known as a “Cyclone” as one example of this type of condensing method.

While a cyclone device is one type of separating machine that uses centrifugal force, the device itself does not produce the centrifugal force, but rather the centrifugal force that is produced through the rotational force of the air that flows in is used to separate the particles. This device has the benefits of being relatively simple in structure, and having large processing capabilities (high condensing efficiency). However, when the flow rate of the gas (or fluid) that is supplied to the cyclone device is too high, or the particle diameter of the particles that are subject to concentration (separation) within the gas is too large, then there is a tendency for the number of particles included within the gas that is the output of the concentration to fall, as shown in, for example, FIG. 6 of Lim.

Given this, an aspect of the present invention is to increase the scope (the processing flow rates and particle diameters of the samples) over which the cyclone device can be used. Moreover, another aspect is to increase the performance of particle detecting apparatuses that use cyclone devices.

### SUMMARY

An example of the particle condensing apparatus according to the present invention, for solving the problem set forth above, includes a gas-borne particle condensing device that condenses a gas that includes gas-borne particles. The gas-borne particle condensing device includes a cyclone portion that causes a supplied first gas to swirl along an inner wall face to cause centrifugal force to act on particles in the first gas to produce a second gas with a relatively high particle concentration and a third gas with a low particle concentration. A fluorocarbon polymer film is formed on an inner wall face of the cyclone portion.

In this structure, the wall faces of the interior of the cyclone are covered with a fluorocarbon polymer film. The fluorocarbon polymer film has the properties of having low friction and being non-stick, and it is understood, through the results of a variety of experiments, that the effect of reducing the adhesion of particles on the inner wall surface, caused by the centrifugal force, is remarkably more than for other materials.

The reason why the number of particles included in the second gas (the output gas) is reduce when the flow rate of the first gas that is supplied, as described above, exceeds a given quantity, or when the diameter of the particles exceeds a given size, is that the particles are caused, by the increase in the centrifugal force, to adhere to the inner wall face of the cyclone, so as to not exit to the outside (in the second gas).

Given this, in the present invention, a state is creating wherein it is difficult for the particles to adhere to the surface of the inner wall face of the cyclone portion that generates a swirling flow. As a result, even if there is an increase in the centrifugal force that acts on the particles, through an increase in the flow rate (an increase in the speed of flow) of the gas that is supplied to the cyclone device, it is still possible to reduce the number of particles that adhere to the wall faces on the interior of the cyclone, making it possible to prevent a reduction in the concentration efficiency even when there is an increase in the processing flow rate of the gas. Moreover, this enables larger particles to be subject to detection as well. The “concentration efficiency” is represented by “the number of particles included in the second gas (the output gas) divided by the number of particles included in the first gas.”

Here “fluorocarbon polymers” refers to synthetic polymers that include fluorine. PTFE (polytetrafluoroethylene), PDA (perfluoroalkylvinylether-tetrafluoroethylene copolymer), FEP (hexafluoropropylene-tetrafluoroethylene copolymer), ETFE (ethylene-tetrafluoroethylene copolymer), PVDF (polyvinylidene fluoride), PCTFE (polyfluorotrifluoroethylene), ECTFE (ethylene-chlorotrifluoroethylene copolymer), and the like, for example, can be listed as fluorocarbon polymers, but there is no limitation thereto. PTFE is sold as “Teflon” (a registered trademark of DuPont Corporation).

Preferably, the cyclone portion described above includes a round cylindrical portion for causing the supplied air to swirl along the inner wall face thereof, and a round cylindrical portion, having an inner wall face of a round conical shape (or a funnel shape), wherein the radius of rotation of the swirling gas becomes smaller toward the outlet thereof, wherein a fluorocarbon polymer film is formed on the inner wall surfaces of the round cylindrical portion and of the round conical portion. As a result, this enables a reduction in the number of particles that adhere through collision with the inner wall faces due to the centrifugal force due to the swirling flow of the gas, produced by the cyclone portion. This enables an increase in the concentration efficiency of the gas through an increase in the flow rate of the supply gas. Moreover, this enables particles with larger diameters (relative to that which is conventional) to be subject to detection.

Preferably, the formation of the fluorocarbon polymer film is a coating treatment (thin-film formation) or a lining treatment (thick-film formation) of the fluorocarbon polymer onto the interior wall face of the cyclone portion. Doing so enables the formation of a fluorocarbon polymer film on the inner wall faces of the cyclone portion. Moreover, if using the thick-film formation, this makes it easy to avoid the production of pinholes in the fluorocarbon polymer film due to the state of the surface of the inner walls faces, due to a treatment of the underlying layer, or the like.

Moreover, the particle detecting apparatus according to the present invention comprises the particle condensing apparatus described above, a first pump for regulating the flow rate of the output gas of the particle condensing apparatus to a specific value, a second pump for regulating the flow rate of an exhaust gas of the particle condensing apparatus to a specific value, and particle detecting unit that detects particles in the output gas. Note that, instead of the first and second pumps, two negative pressures (or positive pressures) may be formed using a single pump and a pressure regulating device. This structure enables efficient particle detection through causing a large volume of gas that is subject to detection to become a small volume of gas. The particle detecting unit is preferably an optical particle detecting device, but instead a microorganism filter, culturing, or the like, may be used.

Preferably, the particle detecting unit is an optical microorganism detecting device. This enables the real-time evaluation of whether a particle is an inorganic particle or an organic particle. The optical microorganism detecting device, for example, illuminates a particle with a detection beam and detects the scattered light or florescent light from the particle. The existence and size of a particle can be evaluated by the level of the reflected light, and whether or not the particle is a microorganism can be evaluated by whether or not there is florescent light.

The particle condensing apparatus according to the present invention reduces the adhesion of particles to the inner wall faces in the cyclone portion, thus enabling a delay in the point in time at which there is a reduction in the function for separating the gas and the particles because of the adhesion of the particles to the inner wall faces of the cyclone portion, even when the centrifugal force that acts on the particles is increased due to an increase in the flow rate of the supply gas or an increase in the particle size. This enables an increase in the condensing efficiency (the number of particles in the gas that is outputted from the cyclone portion divided by the number of particles in the gas that is supplied to the cyclone portion). Moreover, there is the benefit of enabling inspection particles of diameters that are larger than in the past to also be subject to detection. Moreover, this enables processing of a large volume of the gas that is subject to detection, so convenience is good.

### BRIEF DESCRIPTIONS OF THE DRAWINGS

FIG. 1 is an explanatory diagram for explaining an example structure of a particle condensing apparatus according to an example according to the present invention.

FIG. 2 is an explanatory diagram for explaining the operation of the cyclone portion.

FIG. 3 is a graph for explaining the separating characteristics of the gas outlet and exhaust opening, depending on the particle diameters in the cyclone portion.

FIG. 4 is an explanatory diagram for explaining an example structure of a cyclone portion.

FIG. 5 is a graph illustrating the condensing efficiency characteristics, as a function of the processing flow rate, for a standard processing method, a chrome plating treatment, an electrolytic polishing treatment, and a fluorocarbon polymer treatment on the inner wall of the cyclone portion.

FIG. 6 is a graph for explaining the condensing efficiency characteristics, as a function of the particle size, for a standard processing method, a chrome plating treatment, an electrolytic polishing treatment, and a fluorocarbon polymer treatment on the inner wall of the cyclone portion.

FIG. 7 is a graph for explaining the condensing efficiency for various types of surface treatments when the flow rate in the cyclone is increased.

### DETAILED DESCRIPTION

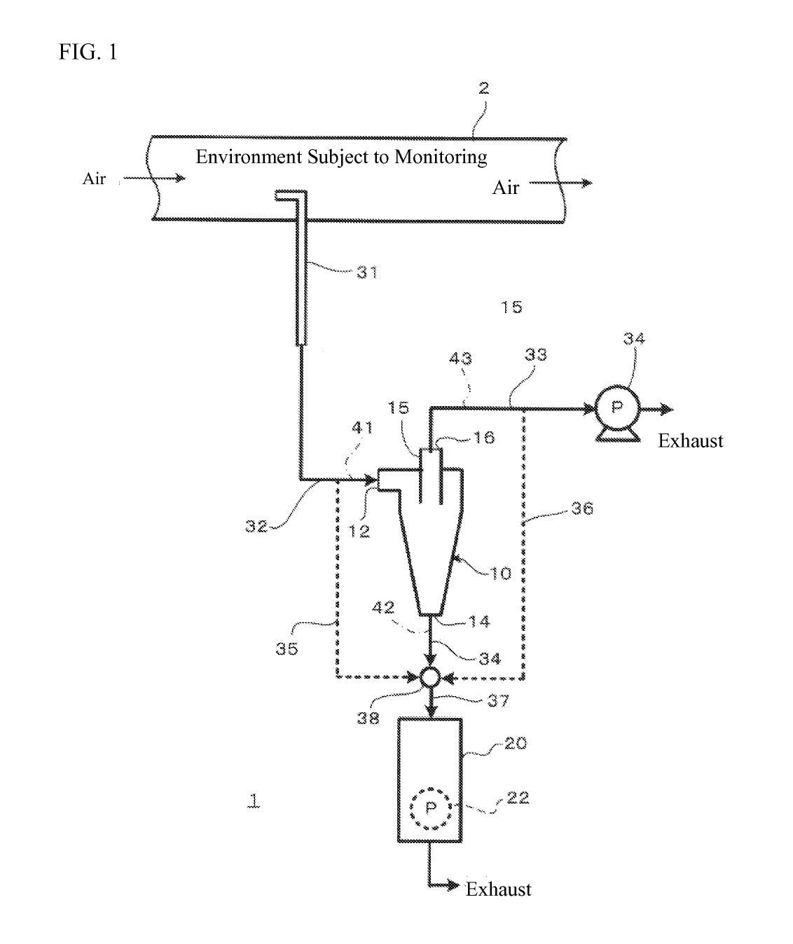

An example according to the present invention will be explained below, referencing the figures. First a particle detecting apparatus having a gas condensing function will be explained in reference to FIG. 1. In this figure, broadly divided, a particle detecting apparatus 1 and an environment 2 that is subject to monitoring are illustrated. The environment 2 that is subject to monitoring is, for example, an air supplying system, or the like, for a manufacturing facility for pharmaceuticals or semiconductor devices, wherein manufacturing quality is affected by the existence of microparticles in the air, or, in particular, for a hospital or laboratory requiring a clean environment, or for air-conditioning equipment in a building.

The particle detecting apparatus 1 is structured from a cyclone portion 10 for performing condensing of particles in a sample gas, a particle detecting unit 20, a sample collecting tube 31, a plurality of tubes 32 through 37, a pump 34, a tube switching device 38 for selecting a detection gas, and the like.

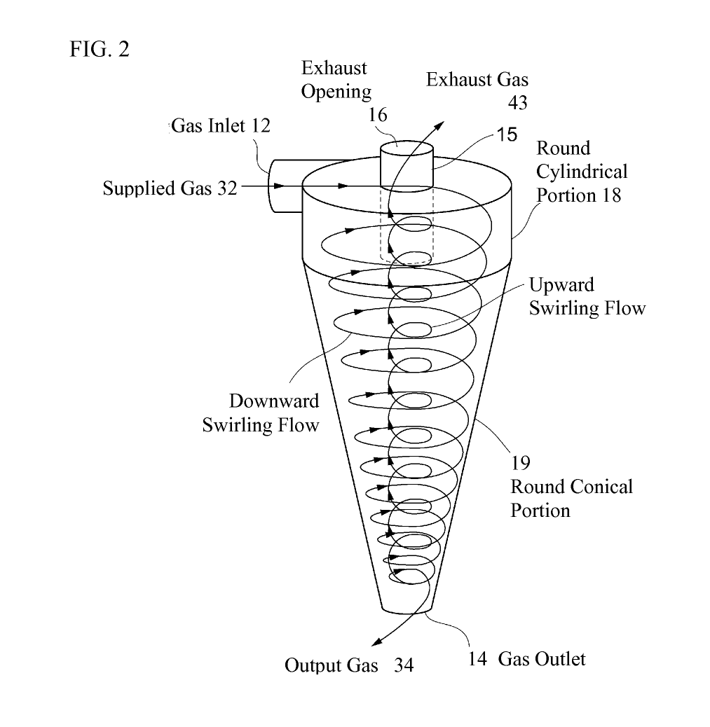

As illustrated in FIG. 2, the cyclone portion 10, broadly divided, is structured from a round cylindrical portion and a round conical portion, where the round cylindrical portion, on the side face thereof, is provided with a gas inlet 12 for supplying a sample gas, and a gas exhaust tube 15 that is disposed in the axial part of the round cylindrical portion. The upper part of the gas exhaust tube 15 is an exhaust opening 16 for exhausting, to the outside, gas from which particles have been removed. In the cylindrical portion, the inner wall thereof is formed into a round cylindrical shape, where gas that flows in from an inlet is caused to swirl in a doughnut-shaped annular space that is formed between the inner wall and the outer wall of the gas exhaust tube 15, to produce centrifugal forces in the gas. The particles in the gas, which are relatively heavier than the gas molecules, move toward the wall side while undergoing swirling.

The round conical portion has an inner wall of a funnel shape wherein the inner diameter becomes smaller toward the gas outlet 14 that is formed on the bottom portion, to guide the swirling flow of gas that is produced by the round cylindrical portion toward the gas outlet 14 as a downward swirling flow along the inner wall. At this time, an upward swirling flow is produced along the axis of the eddy of the downward swirling flow, and is guided to the exhaust opening 16 by the gas exhaust tube 15, described above. The particles within the gas are moved by the centrifugal force to the downward swirling flow side, and thus the particle concentration within the gas that is outputted from the gas outlet 14 is a relatively high concentration. This structure makes it possible to condense the particles that are within the gas that is supplied.

Here the condensing efficiency C is defined as C=NOUT/NIN, which is the ratio of number of particles NOUT that are included in the gas of the outlet 14 divided by the number of particles NIN in the gas that is supplied to the gas inlet 12. In the present example, in order to improve the condensing efficiency C, a fluorocarbon polymer treatment is performed on the inner wall faces of the cyclone portion (including the round cylindrical portion and the round conical portion) so as to make it difficult for particles to adhere thereto, thus reducing the particles that are retained on the inner walls because of an increase in the centrifugal force.

The particle detecting unit 20 can use an optical microorganism detecting device that is identical to that which is set forth in the WO '643. The optical microorganism detecting device, although not illustrated in particular, may, for example, be structured from a tube that carries a sample gas (a gas that includes the particles that are subject to detection) to a monitoring position, a pump 22, an excitation beam light source for emitting a laser beam, as the excitation beam, to the monitoring position, an optics system for focusing scattered light from the particles, an optical sensor for converting scattered light into an electric signal, an optical system for focusing fluorescent light that is produced by microorganism particles due to excitation by the excitation beam, a fluorescent light sensor for converting the florescent light into an electric signal, a computer system for processing the electric signals, and the like. The excitation beam light source may use any of a variety of light sources, such as a solid-state laser light source, a gas laser light source, a semiconductor laser light source, or the like. Moreover, the excitation light source need only be able to produce an excitation beam that is able to produce florescent light and scattered light from the microorganisms (particles), and is not limited to any particular type of light source, such as a laser beam source, or the like. It may instead be an LED (light-emitting diode) light source, or the like. The evaluation of the microparticles and microorganisms is through, for example, an application program of a computer system evaluating whether or not there are particles present, the sizes of the particles, and the like, based on the levels of scattered light. Moreover, whether or not there are microorganisms, and the types of microorganisms, are evaluated by the florescent light. The real-time detection results for particles within the gas are used as control information for a gas (air) cleaning plant, the like, not shown, to enable maintenance, and so forth, of the environment that is subject to monitoring.

A gas supplying system is structured as appropriate from tubes, and the like, to cause the essential structural elements, described above, to function. For example, the gas (air) 41 that is extracted by the sample collecting tube 31 that is disposed in an appropriate location in the environment 2 that is being monitored is supplied to the gas inlet 12 of the cyclone portion 10 by a tube 32. The gas 42 that is outputted from the gas outlet 14 of the cyclone portion 10 is supplied to the particle detecting unit 20 through a tube 34, a switching device 38, and a tube 37. Moreover, the gas 43 that is outputted from the exhaust opening 16 of the cyclone portion 10 is drawn in by a pump 34 through a tube 33, to be exhausted.

The gas 41 of the tube 32 is supplied through a tube 35 to the switching device 38. Moreover, the gas 42 is supplied through the tube 34. Furthermore, the gas 43 of the tube 33 is supplied through a tube 36. The switching device 38 is switched either manually or through a computer system, or the like, and the operation of the pumps 22, 34, and the like are controlled as necessary to supply a selected gas through a tube 37 to the particle detecting unit 20. The selection, by the switching device 38, of the gas that is to be subject to inspection enables detection of the number of particles in the supply gas 41, the number of particles in the output gas 42, the number of particles in the exhaust gas 43, and the like. Note that, although not illustrated in particular, if necessary it is possible to provide pumps and pressure regulating devices in the tubes, and the flow rates of the gases in the respective tubes can be detected through a flow rate meters, calculations, and the like. Moreover, rather than providing the switching device 38, the number of particles in the gases of the respective tubes may instead be measured through a plurality of particle counters.

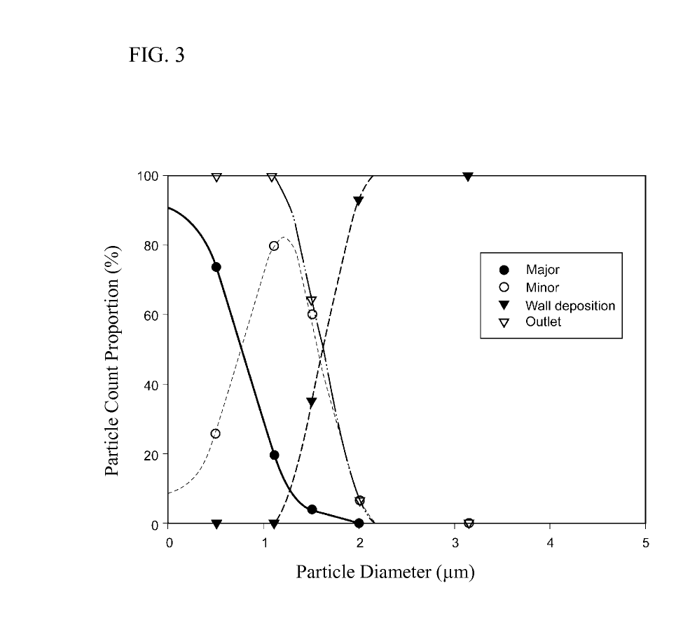

FIG. 3 is a graph illustrating examples of particle separation characteristics as a function of particle diameters at specific flow rates in the cyclone portion described above. In this figure, the horizontal axis shows the sizes of the sample particles (the particle diameters, in units of micrometers). The vertical axis shows the proportions of the number of particles (in units of percentages). In this example, the numbers of particles in the air that is outputted at the exhaust opening 16 and the gas outlet 14 are calculated for five different sample particle diameters of 0.5, 1.1, 1.5, 2, and 3.1 μm, under an airflow rate condition of 70 l/min.

In this graph, the curve indicated by the black circle sampling points shows the curve for the proportion of the number of particles in the exhaust gas 43. The curve indicated by the white circle sampling points shows the curve for the proportion of the number of particles in the output exhaust gas 43. The curve indicated by the black triangle sampling points shows the curve for the proportion of the number of particles captured on the wall faces. The curve indicated by the white triangle sampling points shows the curve for the proportion of the number of particles that are exhausted to the outside (the sum of the black circles and the white circles).

From the results of the above, it is understood that when the particle diameter is about 1.1 μm, the particles are separated efficiently (about 80%) and outputted from the outlet 14, and that condensing is possible for only a specific range of particle diameters. Moreover, when the particle diameter exceeds about 2.1 μm, the particles are not outputted to outside of the cyclone. This is believed to be due to the increase in the centrifugal force that acts on the particles when the particle diameters are large, which causes the particles to be pressed against the inner walls of the cyclone, to remain within the cyclone. Moreover, although not illustrated, when the flow rate of the gas is increased, if more than a given flow rate, the centrifugal force acting on the particles increases, and the particles cease to be outputted to the outside of the cyclone.

In this way, the cyclone has the characteristics of “the centrifugal force on the particles increasing as the processing flow rate increases, to produce a strong condensing effect, but when the flow rate or particle size exceeds given amounts, there is an increase in the particles that adhere to the wall faces, causing a decrease in the number of particles that can be recovered.” Thus there is the need to be able to collect particles with a broad range of particle diameters that exist in the environment that is subject to monitoring when detecting particles by condensing the airborne particles (or airborne microorganisms) using a cyclone. The present example has the distinctive feature of a treatment having been performed on the wall faces in order to reduce the number of particles that adhere to the inner wall faces of the cyclone.

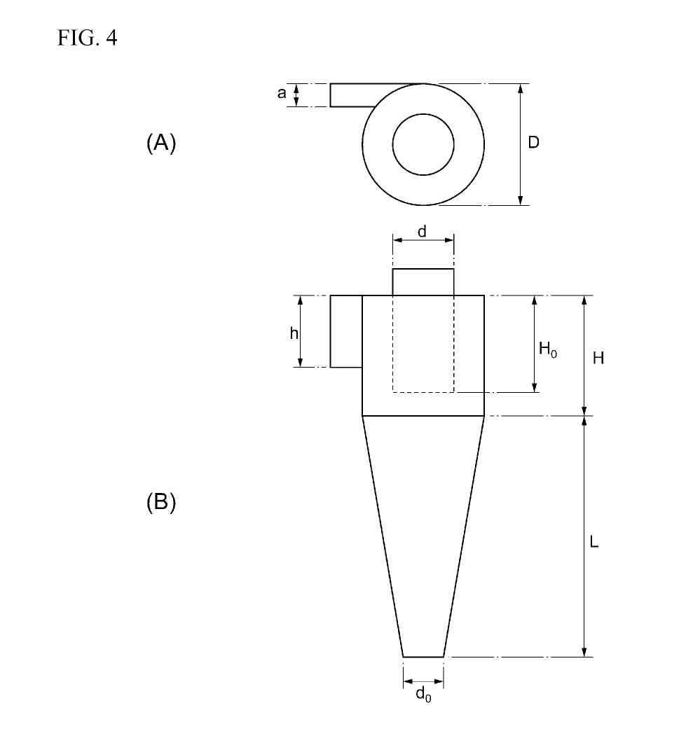

The inventors created cyclones (made out of aluminum) shaped as illustrated in FIG. 4, and formed (at least) the gas flow paths (including the inner walls of the round cylindrical portions and the inner walls of the round conical portions) with a non-treated aluminum surface (standard), a chrome-plated surface, an electrolytically polished surface, and a polymer (fluorocarbon polymer)-treated surface, and conducted experiments regarding the adhesion, and the like, of particles.

FIG. 4 (A) is a top view of a sample cyclone, and (B) is a side view of the same sample. The width a of the inlet portion of the round cylindrical portion is 3 mm, and the height h is 9 mm. The diameter D of the round cylindrical portion is 15 mm, and the height H is 15 mm. For the gas exhaust tube, the diameter d is 7.5 mm, and the height HO is 12 mm. For the round conical portion, the diameter D of the top portion is 15 mm, and the diameter dO of the bottom portion is 4.5 mm, with a height L of 30 mm.

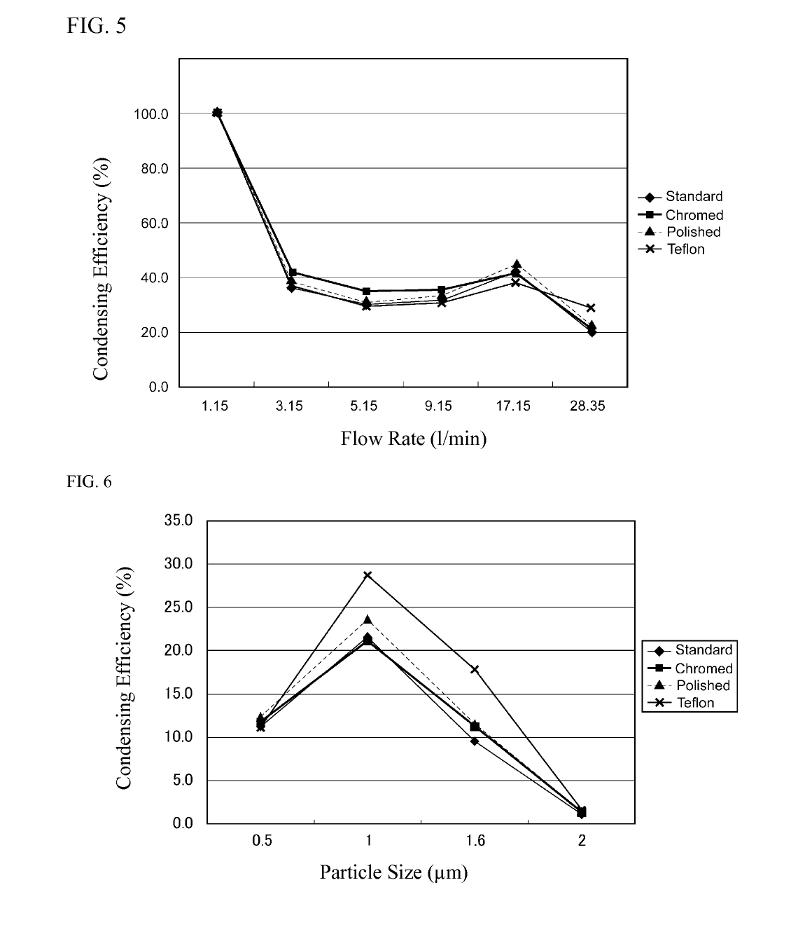

FIG. 5 is a graph illustrating the experimental results for the adhesion of the particles. In this figure, the horizontal axis indicates the flow rate of the gas, and the vertical axis indicates the condensing efficiency (the number of particles 42 at the outlet divided by the number of particles 41 at the inlet). In the experiments, measurements were performed with a concentration of approximately 16,000 particles per liter of sample particles with a particle diameter of 1 μm in the gas, provided at flow rates of 1.15, 3.15, 5.15, 9.15, 17.15, and 28.35 l/min, and a flow rate of 1.15 l/min, for the output gas for each of the four surface treatments.

For the individual curves in the figure, the curve where the sampling points are diamonds (♦) shows the example for the standard form (no surface treatment), the curve wherein the sampling points are squares (Δ) shows the example of the chrome treatment, the curve wherein the sampling points are triangles (▴) shows the example of the polishing treatment, and the curve wherein the sampling points are X marks (X) shows the example of the fluorocarbon polymer treatment. As illustrated in FIG. 5, the condensing efficiency characteristics are essentially the same for each of the treatments for flow rates of 1.5 up to 17.15 l/min, but when the flow rate of the gas reached 28.35 l/min, the condensing efficiency dropped to between 20 and 22.5% for the examples of the standard form, the chrome plating treatment, and the electrolytic polishing treatment, where, in contrast, the condensing efficiency for the case of the fluorocarbon polymer treatment was 28.8%, so the reduction was small. This can be considered to be because of the reduction in the number of particles captured on the inner walls of the cyclone due to the fluorocarbon polymer treatment when the centrifugal force is increased due to the increase in the flow rate.

FIG. 6 is a graph showing the results of experiments regarding the adhesion of particles depending on the particle size. The condensing efficiency was measured for concentrations of approximately 16,000 particles per liter of sample particles with particle diameters of 0.5, 1, 1.6, and 2 μm in the gas, supplied at a flow rate of 28.35 l/min, for the same four surface treatments as described above, with an output gas flow rate of 1.15 l/min.

For the individual curves in FIG. 6, the curve where the sampling points are diamonds shows the example for the standard form (no surface treatment), the curve wherein the sampling points are squares shows the example of the chrome plating treatment, the curve wherein the sampling points are triangles shows the example of the electrolytic polishing treatment, and the curve wherein the sampling points are X marks shows the example of the fluorocarbon polymer treatment. As shown in the figure, while, with a particle size of 0.5 μm, the condensing efficiency characteristics are essentially equal for each of the surface treatments, when the particle size is 1 μm, the fluorocarbon polymer treatment had the highest condensing efficiency at about 29% (versus 23% for the electrolytic polishing treatment). Moreover, even when the particle size is increased, the reduction in condensing efficiency is still less than for the other surface treatments. This can be considered to be because of the reduction in the number of particles captured on the inner walls of the cyclone due to the fluorocarbon polymer treatment when the effect of the centrifugal force on the particles is increased due to the increase in the particle size. Moreover, when the particle diameter is large, at about 2 μm, so that the centrifugal force that acts on the particles is increased, the particles ceased to be outputted to the outside of the cyclone for all of the surface treatments, making condensation impossible. In this way, the fluorocarbon polymer treatment has the benefit of reducing the drop in condensing efficiency even when there is an increase in the centrifugal force due to an increase in the particle diameter, through reducing the number of particles captured on the wall surfaces within the cyclone.

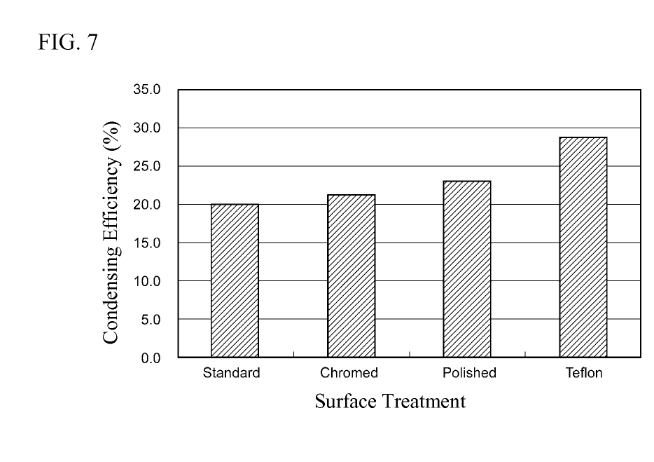

FIG. 7 is a graph showing the condensing efficiencies with various surface treatments at a gas flow rate of 28.35 l/min. In this experiment, PFD (polytetrafluoroethylene) with the product name of “Teflon” (DuPont Corporation registered trademark) 959-1205 was used as the fluorocarbon polymer. The fluorocarbon polymer-coated film may either be a coating (a film thickness of 1 mm or less) or a lining (a film thickness of 1 mm or more). Note that the Teflon coating film can be formed using a well-known method.

Instead of this, PTFE (polytetrafluoroethylene), PDA (perfluoroalkylvinylether-tetrafluoroethylene copolymer), FEP (hexafluoropropylene-tetrafluoroethylene copolymer), ETF (ethylene-tetrafluoroethylene copolymer), PVDF (polyvinylidene fluoride), PCTFE (polyfluorotrifluoroethylene), ECTFE (ethylene-chlorotrifluoroethylene copolymer), and the like, having the same characteristics, can also be used for the fluorocarbon polymer.

Note that while one can consider various types of polymer coatings/linings, such as a urethane coating, a polyvinyl chloride coating, an epoxy polymer lining, a polyvinyl chloride lining, or the like, when the emphasis is on the coated surface having the characteristic of preventing the adhesion of particles, preferably a fluorocarbon polymer is selected.

The fluorocarbon polymer-treated cyclone portion, described above, condenses the particles in a large volume of gas efficiently and supplies them to the particle detecting device to enable particle detection, thereby enabling the measurement of the particles in a large volume of gas to be performed more efficiently in a shorter time than has been done conventionally (through a cyclone portion wherein the inner wall surfaces have not been treated). Moreover, because a large quantity of microparticles or microorganisms can be detected, this is particularly convenient when detecting bacteria wherein the mere existence thereof is problematic. Note that while in the present example the explanation was for a case of detecting particles within a gas, the gas is not limited to air. These may instead be particles in a carrier gas such as nitrogen. Moreover, this may be applied also to a device for detecting particles in a liquid, for detecting and measuring, for example, microorganisms particles in a liquid.

As explained above, in the particle condensing apparatus according to the present invention (the cyclone), a surface treatment using a fluorocarbon polymer is performed on the interior walls of the flow paths within the device main unit. This enables a reduction in the adhesion of particles to the interior walls of the device that would accompany an increase in the processing flow rate or an increase in the particle diameters, enabling suppression of the decrease in the condensing efficiency due to the processing flow rate or the particle diameter, and thus is desirable. Moreover, the particle detecting apparatus according to the present invention has excellent particle detection efficiency due to performing detection after condensing the particles within the gas.

1. A particle condensing apparatus comprising:
a gas-borne particle condensing device that condenses a gas that includes gas-borne particles, the gas-borne particle condensing device including
a cyclone portion that causes a supplied first gas to swirl along an inner wall face to cause centrifugal force to act on particles in the first gas to produce a second gas with a relatively high particle concentration and a third gas with a low particle concentration, wherein
a fluorocarbon polymer film is formed on an inner wall face of the cyclone portion.

2. The particle condensing apparatus as set forth in claim 1, wherein
the cyclone portion includes
a round cylindrical portion that causes a supplied gas to swirl along an inner wall face; and
a round conical portion having a round conical inner wall face that causes the radius of rotation of the swirling gas to be reduced toward an outlet, wherein
the fluorocarbon polymer film is formed on inner wall faces of the round cylindrical portion and of the round conical portion.

3. The particle condensing apparatus as set forth in claim 2, wherein
formation of the fluorocarbon polymer film is a coating treatment or a lining treatment of a fluorocarbon polymer onto an interior wall face of the cyclone portion.

4. A particle detecting apparatus comprising:
a particle condensing apparatus including
a gas-borne particle condensing device that condenses a gas that includes gas-borne particles, the gas-borne particle condensing device including
a cyclone portion that causes a supplied first gas to swirl along an inner wall face to cause centrifugal force to act on particles in the first gas to produce a second gas with a relatively high particle concentration and a third gas with a low particle concentration, wherein
a fluorocarbon polymer film is formed on an inner wall face of the cyclone portion;
a first pump that regulates, to a specific value, a flow rate of the second gas of the particle condensing apparatus;
a second pump that regulates, to a specific value, a flow rate of the third gas of the particle condensing apparatus; and
a particle detecting unit that detects a particle in the second gas.

5. That particle detecting apparatus as set forth in claim 4, wherein:
the particle detecting unit is an optical microorganism detecting device.
